(19) United States
(12) Patent Application Publication
(10) Pub. No.: US 2016/0044559 A1
(43) Pub. Date: Feb. 11, 2016

(54) METHOD AND APPARATUS FOR TRANSMITTING HANDOVER REQUEST MESSAGE IN WIRELESS COMMUNICATION SYSTEM

(71) Applicant: LG ELECTRONICS INC., Yeongdeungpo-gu, Seoul (KR)

(72) Inventors: Jian XU, Seoul (KR); Daewook BYUN, Seoul (KR); Insun LEE, Seoul (KR); Kyungmin PARK, Seoul (KR)

(73) Assignee: LG ELECTRONICS INC., Seoul (KR)

(21) Appl. No.: 14/776,433

(22) PCT Filed: Mar. 28, 2014
(86) PCT No.: PCT/KR2014/002693

§ 371 Date: Sep. 14, 2015

Related U.S. Application Data
(60) Provisional application No. 61/806,409, filed on Mar. 29, 2013.
(60) Provisional application No. 61/929,513, filed on Jan. 21, 2014.

(51) Int. Cl. H04W 36/08; H04W 36/00

(52) U.S. Cl. CPC H04W 36/08; H04W 36/0005

(57) ABSTRACT

A method and apparatus for transmitting a handover request message in a wireless communication system is provided. For service differentiation from a small cell and a macro cell, a first macro eNodeB (eNB) transmits a handover request message including a list of first services for a user equipment (UE), which are provided by the first macro eNB, and a list of second services for the UE, which are provided by a small cell eNB which has dual connectivity with the first macro eNB.

### TECHNICAL FIELD

The present invention relates to wireless communications, and more particularly, to a method and apparatus for transmitting a handover request message in a wireless communication system.

### BACKGROUND ART

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

The eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 2 shows a control plane of a radio interface protocol of an LTE system. FIG. 3 shows a user plane of a radio interface protocol of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARM) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 2, the RLC and MAC layers (terminated in the eNB on the network side) may perform functions such as scheduling, automatic repeat request (ARQ), and hybrid automatic repeat request (HARM). The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

Referring to FIG. 3, the RLC and MAC layers (terminated in the eNB on the network side) may perform the same functions for the control plane. The PDCP layer (terminated in the eNB on the network side) may perform the user plane functions such as header compression, integrity protection, and ciphering.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped to the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined. The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof. This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance. There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULInterference, TransmitPilot and Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value In the UL in the signature.

Small cells using low power nodes are considered promising to cope with mobile traffic explosion, especially for hotspot deployments in indoor and outdoor scenarios. A low-power node generally means a node whose transmission (Tx) power is lower than macro node and base station (BS) classes, for example a pico and femto eNodeB (eNB) are both applicable. Small cell enhancements for the 3GPP LTE will focus on additional functionalities for enhanced performance in hotspot areas for indoor and outdoor using low power nodes.

An X2 handover procedure with the existence of small cells should be enhanced.

### SUMMARY OF INVENTION

### Technical Problem

The present invention provides a method and apparatus for transmitting a handover request message in a wireless communication system. The present invention provides a method for transmitting a handover request message including additional indication and/or information for a small cell during X2 handover.

### Solution to Problem

In an aspect, a method for transmitting, by a first macro eNodeB (eNB), a handover request message in a wireless communication system is provided. The method includes transmitting a handover request message including a list of first services for a user equipment (UE), which are provided by the first macro eNB, and a list of second services for the UE, which are provided by a small cell eNB which has dual connectivity with the first macro eNB.

The method may further include handing over the UE to a second macro eNB which supports dual connectivity potentially with the small cell eNB. The handover request message may be transmitted to the second macro eNB. The first services may be handed over to the second macro eNB. The second services may be totally kept in the small cell eNB, or the second services may be not kept in the small cell eNB but indirectly handed over from the small cell eNB to the second macro eNB going through the first macro eNB.

The method may further include handing over the UE to a pico eNB which is the small cell eNB. The handover request message may be transmitted to the pico eNB. The first services may be handed over to the pico eNB. The second services may be kept in the small cell eNB.

The list of first services may correspond to a list of first E-UTRAN radio access bearers (E-RABs).

The list of second services may correspond to a list of second E-UTRAN radio access bearers (E-RABs).

The handover request message may include information on current radio resource management of the first macro eNB.

The method may further include receiving a measurement report from the UE.

In another aspect, a method for receiving, by a second macro eNodeB (eNB), a handover request message in a wireless communication system is provided. The method includes receiving a handover request message including a list of first services for a user equipment (UE), which are provided by a first macro eNB, and a list of second services for the UE, which are provided by a small cell eNB which has dual connectivity with the first macro eNB, from the first macro eNB, and providing the first services to the UE.

In another aspect, a method for receiving, by a pico eNodeB (eNB), a handover request message in a wireless communication system is provided. The method includes receiving a handover request message including a list of first services for a user equipment (UE), which are provided by a first macro eNB, and a list of second services for the UE, which are provided by a small cell eNB which has dual connectivity with the first macro eNB, from the first macro eNB, and providing both the first services and the second services to the UE. The pico eNB is the small cell eNB.

### Advantageous Effects of Invention

An X2 handover procedure with existence of small cells can be enhanced.

### BRIEF DESCRIPTION OF DRAWINGS

FIG. 1 shows LTE system architecture.

FIG. 2 shows a control plane of a radio interface protocol of an LTE system.

FIG. 3 shows a user plane of a radio interface protocol of an LTE system.

FIG. 4 shows an example of a physical channel structure.

FIGS. 5 and 6 show an intra-MME/S-GW handover procedure.

FIG. 7 shows deployment scenarios of small cells with/without macro coverage.

FIG. 8 shows an example of a deployment scenario of small cells.

FIG. 9 shows an example of a problem according to a current X2 handover procedure.

FIG. 10 shows another example of a problem according to a current X2 handover procedure.

FIG. 11 shows an example of a method for transmitting a handover request message according to an embodiment of the present invention.

FIG. 12 shows an example of a method for transmitting a handover request message according to another embodiment of the present invention.

FIG. 13 shows a wireless communication system to implement an embodiment of the present invention.

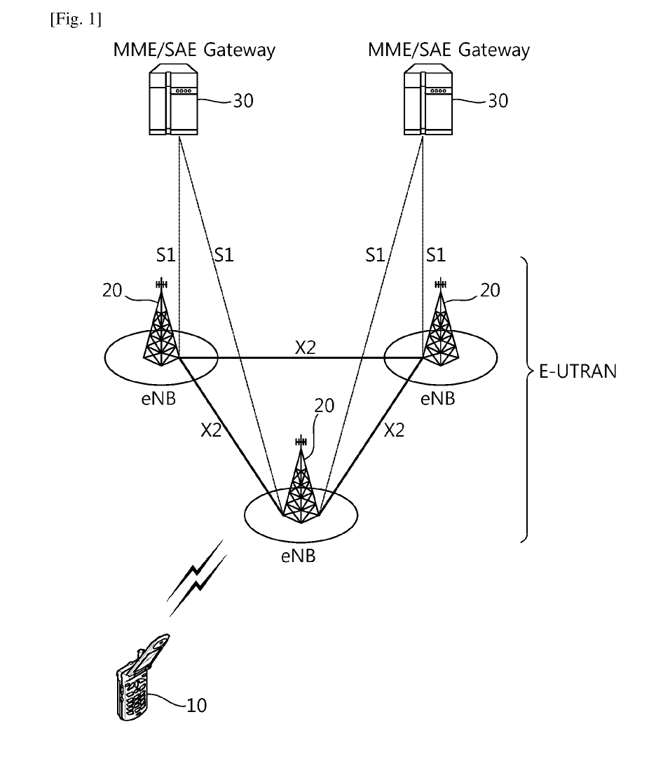

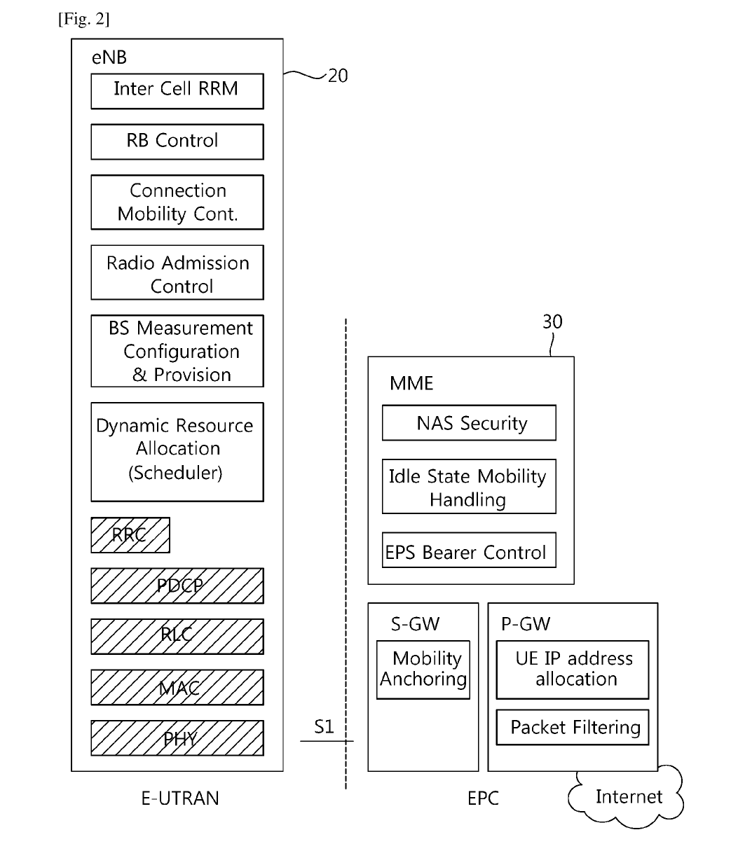

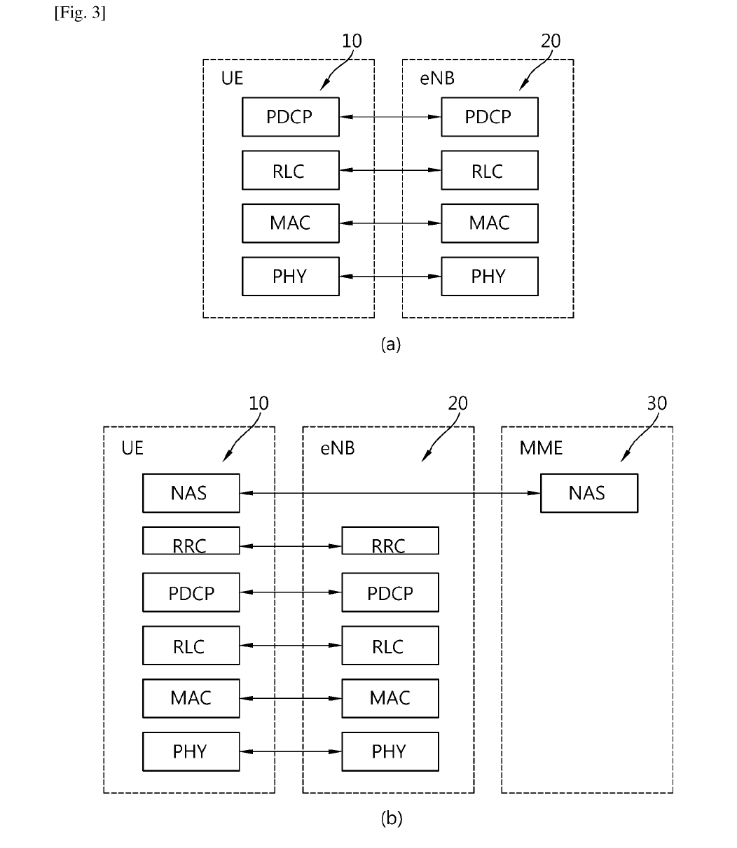

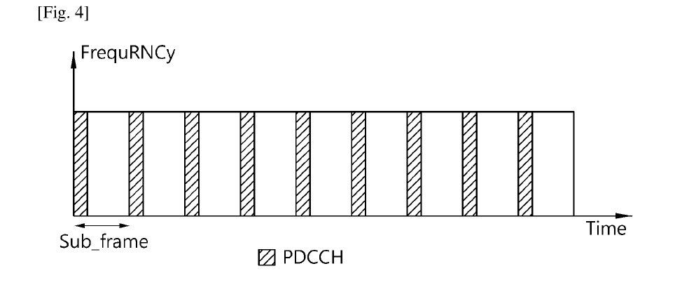

### MODE FOR THE INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink LTE-advance (LTE-A) is an evolution of the 3GPP LTE.

For clarity, the following description will focus on the LTE-A. However, technical features of the present invention are not limited thereto.

Handover (HO) is described. It may be referred to Section 10.1.2.1 of 3GPP TS 36.300 V11.4.0 (2012-12).

The intra E-UTRAN HO of a UE in RRC_CONNECTED state is a UE-assisted network-controlled HO, with HO preparation signaling in E-UTRAN:
Part of the HO command comes from the target eNB and is transparently forwarded to the UE by the source eNB;
To prepare the HO, the source eNB passes all necessary information to the target eNB (e.g., E-UTRAN radio access bearer (E-RAB) attributes and RRC context): When carrier aggregation (CA) is configured and to enable secondary cell (SCell) selection in the target eNB, the source eNB can provide in decreasing order of radio quality a list of the best cells and optionally measurement result of the cells.
Both the source eNB and UE keep some context (e.g., C-RNTI) to enable the return of the UE in case of HO failure;
UE accesses the target cell via RACH following a contention-free procedure using a dedicated RACH preamble or following a contention-based procedure if dedicated RACH preambles are not available: the UE uses the dedicated preamble until the handover procedure is finished (successfully or unsuccessfully);
If the RACH procedure towards the target cell is not successful within a certain time, the UE initiates radio link failure recovery using the best cell;
No robust header compression (ROHC) context is transferred at handover.

First, C-plane handling is described. The preparation and execution phase of the HO procedure is performed without EPC involvement, i.e., preparation messages are directly exchanged between the eNBs. The release of the resources at the source side during the HO completion phase is triggered by the eNB. In case an RN is involved, its donor eNB (DeNB) relays the appropriate S1 messages between the RN and the MME (S1-based handover) and X2 messages between the RN and target eNB (X2-based handover); the DeNB is explicitly aware of a UE attached to the RN due to the S1 proxy and X2 proxy functionality.

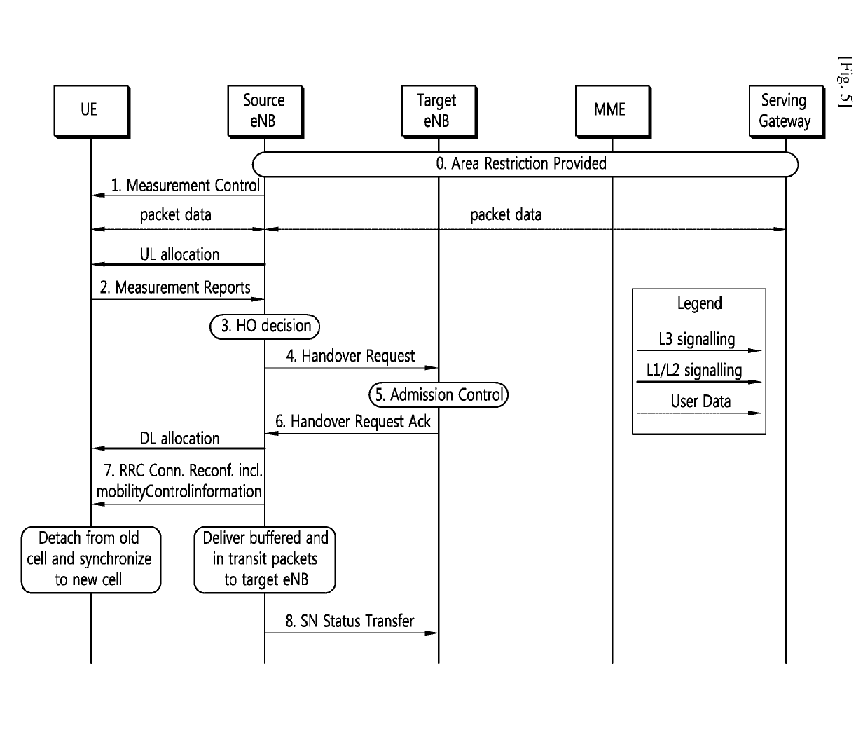

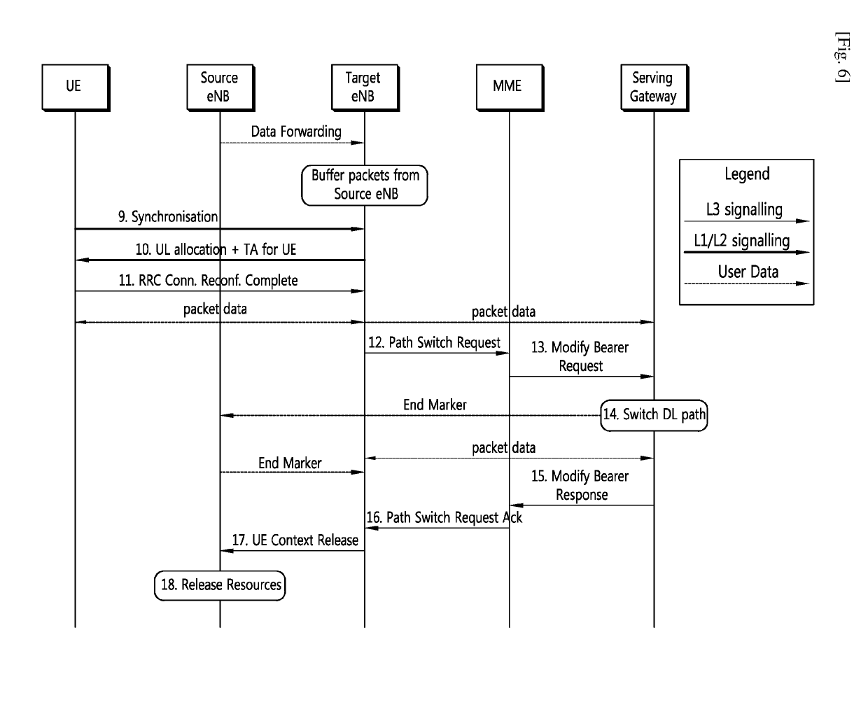

FIGS. 5 and 6 show an intra-MME/S-GW handover procedure.

0. The UE context within the source eNB contains information regarding roaming restrictions which were provided either at connection establishment or at the last TA update.

1. The source eNB configures the UE measurement procedures according to the area restriction information. Measurements provided by the source eNB may assist the function controlling the UE's connection mobility.

2. The UE is triggered to send measurement reports by the rules set by i.e., system information, specification, etc.

3. The source eNB makes decision based on measurement reports and radio resource management (RRM) information to hand off the UE.

4. The source eNB issues a handover request message to the target eNB passing necessary information to prepare the HO at the target side (UE X2 signalling context reference at source eNB, UE S1 EPC signalling context reference, target cell identifier (ID), K_{eNB*}, RRC context including the cell radio network temporary identifier (C-RNTI) of the UE in the source eNB, AS-configuration, E-RAB context and physical layer ID of the source cell+short MAC-I for possible radio link failure (RLF) recovery). UE X2/UE S1 signalling references enable the target eNB to address the source eNB and the EPC. The E-RAB context includes necessary radio network layer (RNL) and transport network layer (TNL) addressing information, and quality of service (QoS) profiles of the E-RABs.

5. Admission Control may be performed by the target eNB dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e., an “establishment”) or as a delta compared to the AS-configuration used in the source cell (i.e., a “reconfiguration”).

6. The target eNB prepares HO with L1/L2 and sends the handover request acknowledge to the source eNB. The handover request acknowledge message includes a transparent container to be sent to the UE as an RRC message to perform the handover. The container includes a new C-RNTI, target eNB security algorithm identifiers for the selected security algorithms, may include a dedicated RACH preamble, and possibly some other parameters, i.e., access parameters, SIBs, etc. The handover request acknowledge message may also include RNL/TNL information for the forwarding tunnels, if necessary.

As soon as the source eNB receives the handover request acknowledge, or as soon as the transmission of the handover command is initiated in the downlink, data forwarding may be initiated.

Steps 7 to 16 in FIGS. 6 and 7 provide means to avoid data loss during HO.

7. The target eNB generates the RRC message to perform the handover, i.e., RRCConnectionReconfiguration message including the mobilityControlInformation, to be sent by the source eNB towards the UE. The source eNB performs the necessary integrity protection and ciphering of the message. The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. The UE does not need to delay the handover execution for delivering the HARQ/ARQ responses to source eNB.

8. The source eNB sends the sequence number (SN) status transfer message to the target eNB to convey the uplink PDCP SN receiver status and the downlink PDCP SN transmitter status of E-RABs for which PDCP status preservation applies (i.e., for RLC AM). The uplink PDCP SN receiver status includes at least the PDCP SN of the first missing UL service data unit (SDU) and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.

9. After receiving the RRCConnectionReconfiguration message including the mobilityControlInformation, UE performs synchronization to target eNB and accesses the target cell via RACH, following a contention-free procedure if a dedicated RACH preamble was indicated in the mobilityControlInformation, or following a contention-based procedure if no dedicated preamble was indicated. UE derives target eNB specific keys and configures the selected security algorithms to be used in the target cell.

10. The target eNB responds with UL allocation and timing advance.

11. When the UE has successfully accessed the target cell, the UE sends the RRCConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin sending data to the UE.

12. The target eNB sends a path switch request message to MME to inform that the UE has changed cell.

13. The MME sends a modify bearer request message to the serving gateway.

14. The serving gateway switches the downlink data path to the target side. The Serving gateway sends one or more “end marker” packets on the old path to the source eNB and then can release any U-plane/TNL resources towards the source eNB.

15. The serving gateway sends a modify bearer response message to MME.

16. The MME confirms the path switch request message with the path switch request acknowledge message.

17. By sending the UE context release message, the target eNB informs success of HO to source eNB and triggers the release of resources by the source eNB. The target eNB sends this message after the path switch request acknowledge message is received from the MME.

18. Upon reception of the UE context release message, the source eNB can release radio and C-plane related resources associated to the UE context. Any ongoing data forwarding may continue.

Small cell enhancement is described. It may be referred to 3GPP TR 36.932 V12.0.0 (2012-12).

FIG. 7 shows deployment scenarios of small cells with/without macro coverage. Small cell enhancement should target both with and without macro coverage, both outdoor and indoor small cell deployments and both ideal and non-ideal backhaul. Both sparse and dense small cell deployments should be considered.

Referring to FIG. 7, small cell enhancement should target the deployment scenario in which small cell nodes are deployed under the coverage of one or more than one overlaid E-UTRAN macro-cell layer(s) in order to boost the capacity of already deployed cellular network. Two scenarios can be considered:
where the UE is in coverage of both the macro cell and the small cell simultaneously
where the UE is not in coverage of both the macro cell and the small cell simultaneously.

Also, the deployment scenario where small cell nodes are not deployed under the coverage of one or more overlaid E-UTRAN macro-cell layer(s) may be considered.

Small cell enhancement should target both outdoor and indoor small cell deployments. The small cell nodes could be deployed indoors or outdoors, and in either case could provide service to indoor or outdoor UEs.

Both ideal backhaul (i.e., very high throughput and very low latency backhaul such as dedicated point-to-point connection using optical fiber, line-of-sight (LOS) microwave) and non-ideal backhaul (i.e., typical backhaul widely used in the market such as xDSL, non-LOS (NLOS) microwave, and other backhauls like relaying) should be studied. The performance-cost trade-off should be taken into account.

For interfaces between macro and small cell, as well as between small cells, the studies should first identify which kind of information is needed or beneficial to be exchanged between nodes in order to get the desired improvements before the actual type of interface is determined. And if direct interface should be assumed between macro and small cell, as well as between small cell and small cell, X2 interface can be used as a starting point.

Small cell enhancement should consider sparse and dense small cell deployments. In some scenarios (e.g., hotspot indoor/outdoor places, etc), single or a few small cell node(s) are sparsely deployed, e.g., to cover the hotspot(s). Meanwhile, in some scenarios (e.g., dense urban, large shopping mall, etc), a lot of small cell nodes are densely deployed to support huge traffic over a relatively wide area covered by the small cell nodes. The coverage of the small cell layer is generally discontinuous between different hotspot areas. Each hotspot area can be covered by a group of small cells, i.e., a small cell cluster.

Furthermore, smooth future extension/scalability (e.g., from sparse to dense, from small-area dense to large-area dense, or from normal-dense to super-dense) should be considered. For mobility/connectivity performance, both sparse and dense deployments should be considered with equal priority.

Both synchronized and un-synchronized scenarios should be considered between small cells as well as between small cells and macro cell(s). For specific operations, e.g., interference coordination, carrier aggregation and inter-eNB coordinated multipoint (COMP), small cell enhancement can benefit from synchronized deployments with respect to small cell search/measurements and interference/resource management. Therefore time synchronized deployments of small cell clusters are prioritized in the study and new means to achieve such synchronization shall be considered.

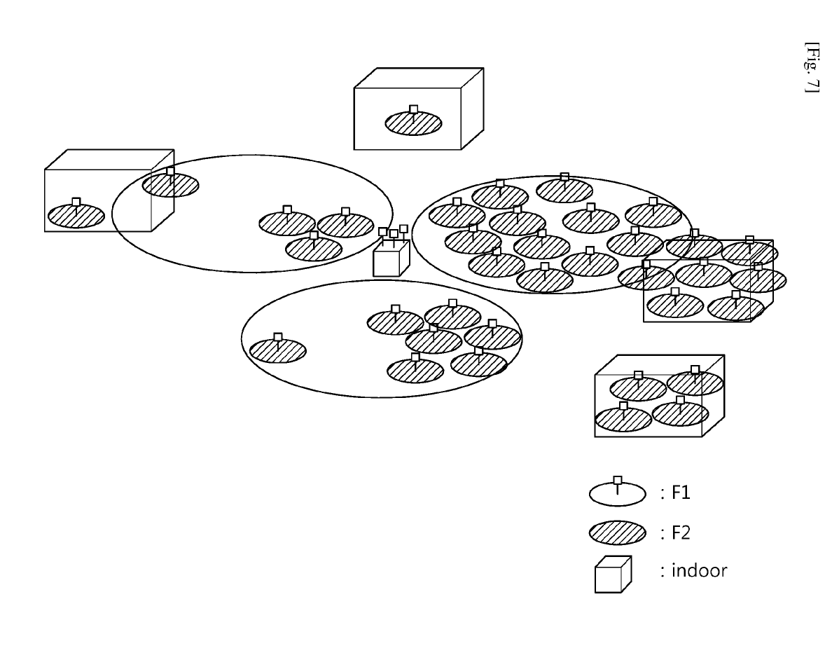

Small cell enhancement should address the deployment scenario in which different frequency bands are separately assigned to macro layer and small cell layer, respectively, where F1 and F2 in FIG. 8 correspond to different carriers in different frequency bands.

Small cell enhancement should be applicable to all existing and as well as future cellular bands, with special focus on higher frequency bands, e.g., the 3.5 GHz band, to enjoy the more available spectrum and wider bandwidth.

Small cell enhancement should also take into account the possibility for frequency bands that, at least locally, are only used for small cell deployments.

Co-channel deployment scenarios between macro layer and small cell layer should be considered as well.

Some example spectrum configurations are:
Carrier aggregation on the macro layer with bands X and Y, and only band X on the small cell layer
Small cells supporting carrier aggregation bands that are co-channel with the macro layer
Small cells supporting carrier aggregation bands that are not co-channel with the macro layer

One potential co-channel deployment scenario is dense outdoor co-channel small cells deployment, considering low mobility UEs and non ideal backhaul. All small cells are under the Macro coverage.

Small cell enhancement should be supported irrespective of duplex schemes (FDD/TDD) for the frequency bands for macro layer and small cell layer. Air interface and solutions for small cell enhancement should be band-independent, and aggregated bandwidth per small cell should be no more than 100 MHz.

In a small cell deployment, it is likely that the traffic is fluctuating greatly since the number of users per small cell node is typically not so large due to small coverage.

In a small cell deployment, it is likely that the user distribution is very fluctuating between the small cell nodes. It is also expected that the traffic could be highly asymmetrical, either downlink or uplink centric.

Both uniform and non-uniform traffic load distribution in time-domain and spatial-domain should be considered. Non-full buffer and full buffer traffic are both included, and non-full buffer traffic is prioritized to verify the practical cases.

Backward compatibility, i.e., the possibility for legacy (pre-Release 12) UEs to access a small-cell node/carrier, is desirable for small cell deployments.

The introduction of non-backwards compatible features should be justified by sufficient gains.

FIG. 8 shows an example of a deployment scenario of small cells. Small cells may be deployed at edge of coverage of macro cells, in order to help to increase user throughput. In this scenario, the edge of coverage of macro cells may also be an area boundary served by different eNBs, and small cell may be deployed as such that it covers the area boundary of the different eNBs. Referring to FIG. 8, a small cell 1 which is controlled by a small cell eNB 1 is deployed at edge of coverage of macro cell 1, macro cell 2, and macro cell 3. A small cell 2 which is controlled by a small cell eNB2 is deployed at edge of coverage of the macro cell 2 and macro cell 3. In this case, the small eNBs may work as a normal pico eNB.

For small cell enhancements, dual connectivity has been discussed. A term “dual connectivity” is used to refer to operation where a given UE consumes radio resources provided by at least two different network points connected with non-ideal backhaul. Furthermore, each eNB involved in dual connectivity for a UE may assume different roles. Those roles do not necessarily depend on the eNB's power class and can vary among UEs. For example, when the UE is in coverage of both a macro cell and small cell, the UE would be typically connected to both the macro cell and one or more small cells simultaneously.

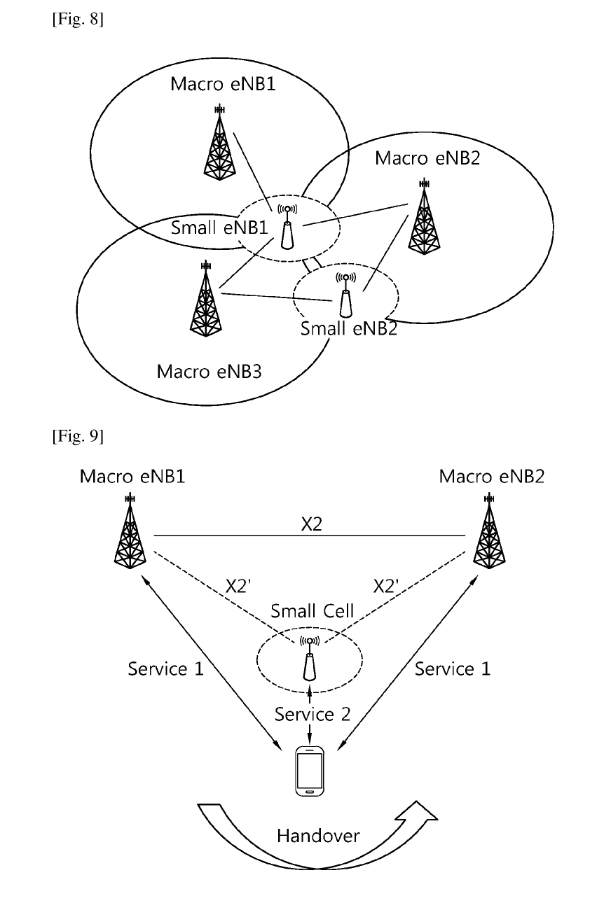

FIG. 9 shows an example of a problem according to a current X2 handover procedure.

Referring to FIG. 9, the UE has dual connectivity with a macro eNB1 and small cell eNB, currently. The macro eNB 1 provides a macro cell 1, and the small cell eNB provides a small cell. It is assumed that for this UE the small cell eNB only takes the role of small cell function. Basically, a small cell eNB has two functions, one of which is a small cell function defined in 3GPP LTE rel-12, and the other is a pico eNB function. Since the small cell eNB has only small cell function for this UE, the small cell eNB is not connected with an MME via S1 interface. The UE is receiving two kinds of services from the macro cell 1 and small cell simultaneously. The UE is receiving a service 1 from the macro cell 1 directly. The UE is also receiving a service 2 from the small cell.

In a certain situation, an X2 handover procedure would happen for that UE. That is, after the handover, the service 1 may be provided by a macro cell 2 which is controlled by a macro eNB2, while the service 2 is still provided by the same small cell no matter that the service 2 is totally kept or not kept. The smart data forwarding can be performed for the X2 interface between the macro eNB2 and small cell eNB. This is a new situation different from the conventional X2 handover procedure, only by which the target macro eNB (i.e., macro eNB2) cannot differentiate the services, i.e., services 1 and 2, for that UE.

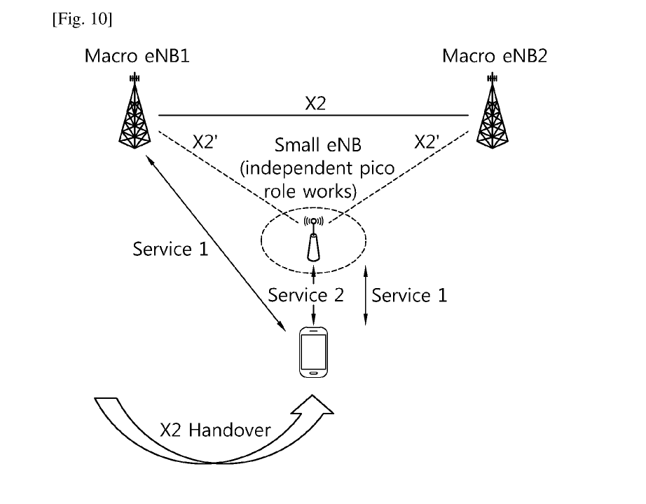

FIG. 10 shows another example of a problem according to a current X2 handover procedure.

Referring to FIG. 10, the UE has dual connectivity with a macro eNB1 and small cell eNB, currently. The macro eNB 1 provides a macro cell 1, and the small cell eNB provides a small cell. It is assumed that the small cell can be an independent pico eNB. That is, the small cell eNB is connected with an MME via S1 interface when it takes the role of eNB. Before handover, the small cell eNB may act as a small cell only. After handover, the small cell may act as an eNB. The UE is receiving two kinds of services from the macro cell 1 and small cell simultaneously. The UE is receiving a service 1 from the macro cell 1 directly. The UE is also receiving a service 2 from the small cell.

In a certain situation, an X2 handover procedure would happen for that UE. That is, after the handover, both of the service 1 and the service 2 may be provided by the small cell. The macro eNB 1 may keep the service 2 to be provided by the small cell, and may just handover the service 1 to the small cell. The macro eNB2 may also take the service 2 back first and then may trigger to handover the service 1 and 2 to the small cell together while the smart data forwarding is performed. This situation is a little bit different from the example described in FIG. 9. It is also different from the conventional X2 handover procedure, only by which the target small cell eNB cannot differentiate the services, i.e., services 1 and 2, for that UE, either.

In addition, according to the conventional X2 handover procedure, in the examples described in FIGS. 9 and 10, the service 2, which is to be kept in the small cell, has to be handed over first to the macro cell 1, then to the macro cell 2, and to the small cell finally. This procedure may cause overhead to the network. A method for enabling forwarding buffered data of the service 2 from the small cell to the macro cell 2 directly, which may called smart data forwarding, may be required. Therefore, to solve the problems described above, a method for performing an X2 handover procedure effectively may be required.

Hereinafter, a method for performing an X2 handover procedure with the existing of the small cell according to embodiments of the present invention is described. According to the embodiments of the present invention, a source eNB may transmit a handover request message with an additional indications and/or information. The present invention may be applied to all the scenarios that require the service differentiation between the service from the small cell eNB and that from the macro eNB.

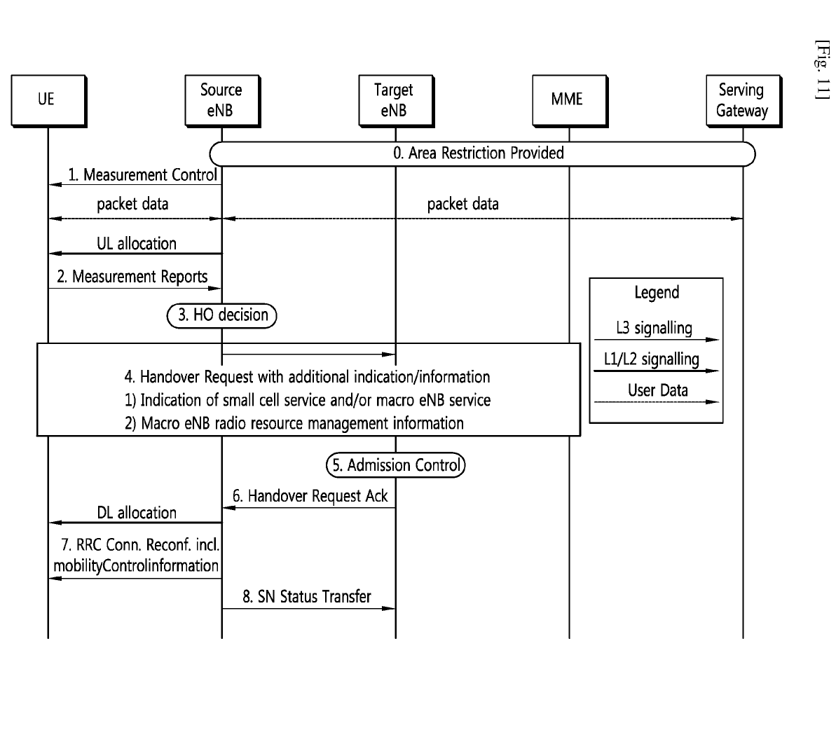

FIG. 11 shows an example of a method for transmitting a handover request message according to an embodiment of the present invention. FIG. 11 shows an embodiment in which a service of the UE is handed over from a source macro eNB 1 to a target macro eNB2. That is, the embodiment described in FIG. 11 corresponds to the embodiment described in FIG. 9.

0. The UE context within the source macro eNB 1 contains information regarding roaming restrictions which were provided either at connection establishment or at the last TA update.

1. The source macro eNB 1 configures the UE measurement procedures according to the area restriction information. Measurements provided by the source macro eNB 1 may assist the function controlling the UE's connection mobility.

2. The UE transmits the measurement report to the source macro eNB 1, which makes a decision for handover a service of the UE to a target macro eNB2. The source macro eNB1 also knows whether the UE is receiving a certain service from small cells controlled by the source macro eNB 1.

3. The source macro eNB 1 makes decision based on measurement reports and RRM information to hand off the UE.

4. The source macro eNB 1 transmits the handover request message to the target macro eNB2.
The handover request message may include an indication indicating that the “E-RABs To Be Setup List” field in the handover request message is for the small cell or the macro eNB. Thus, by the indication, the target macro eNB2 can differentiate the E-RABs for the small cell and the E-RABs for the macro eNB.
The handover request message may include the “E-RABs To Be Setup List” field for the small cell and the “E-RABs To Be Setup List” field for the macro eNB separately with note. Thus the target macro eNB2 can differentiate the E-RABs for the small cell or E-RABs for the macro eNB.
The handover request message may only include the “E-RABs To Be Setup List” field for the macro eNB only if the E-RABs for the small cell is not necessary to be newly setup.
The handover request message may also include information on current radio resource management of the source macro eNB 1, by which the target macro eNB2 can use similar RRM so that the small cell's service can be guaranteed smoothly even after the handover procedure is completed. This is good for the source macro eNB 1 and small cell co-channel situation.

5. The target macro eNB2 adopts different actions for the E-RABs for the small cells and the E-RABs for the macro eNB. For example, deciding which E-RABs should be newly setup, QoS guarantee, deciding whether to transmit a handover request ACK message, deciding of path switch, deciding of data forwarding, etc., may be performed differently according to the E-RABs for the small cells and the E-RABs for the macro eNB.

Subsequent procedures may be the same as the conventional X2 handover procedure, which is described in FIGS. 5 and 6 (from step 6 to 18).

Table 1 shows an example of the handover request message according to the embodiment of the present invention.

TABLE 1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.13 | | YES | reject |
| Old eNB UE X2AP | M | | eNB UE | Allocated at | YES | reject |
| ID | | | X2AP ID | the source | | |
| | | | 9.2.24 | eNB | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context In- | | 1 | | | YES | reject |
| formation | | | | | | |
| >MME UE S1AP | M | | INTEGER | MME UE | — | — |
| ID | | | (0 . . . 2³²- | S1AP ID | | |
| | | | 1) | allocated at | | |
| | | | | the MME | | |
| >UE Security Capa- | M | | 9.2.29 | | — | — |
| bilities | | | | | | |
| >AS Security In- | M | | 9.2.30 | | — | — |
| formation | | | | | | |
| >UE Aggregate | M | | 9.2.12 | | — | — |
| Maximum Bit Rate | | | | | | |
| >Subscriber Profile | O | | 9.2.25 | | — | — |
| ID for RAT/ | | | | | | |
| Frequency priority | | | | | | |
| >>E-RABs To Be | O | 1 | | | — | — |
| Setup List (Small | | | | | | |
| cell) | | | | | | |
| >>E-RABs To Be | | 1 . . . | | | EACH | ignore |
| Setup Item | | <maxnoof | | | | |
| | | Bearers> | | | | |
| >>>E-RAB ID | M | | 9.2.23 | | — | — |
| >>>E-RAB Level | M | | 9.2.9 | Includes | — | — |
| QoS Parameters | | | | necessary | | |
| | | | | QoS pa- | | |
| | | | | rameters | | |
| >>>DL Forwarding | O | | 9.2.5 | | — | — |
| >>>UL GTP | M | | GTP | SGW | — | — |
| Tunnel Endpoint | | | Tunnel | endpoint of | | |
| | | | Endpoint | the S1 | | |
| | | | 9.2.1 | transport | | |
| | | | | bearer. For | | |
| | | | | delivery of | | |
| | | | | UL PDUs. | | |
| >E-RABs To Be | | 1 | | | — | — |
| Setup List (Macro | | | | | | |
| eNB) | | | | | | |
| >>E-RABs To Be | | 1 . . . | | | EACH | ignore |
| Setup Item | | <maxnoof | | | | |
| | | Bearers> | | | | |
| >>>E-RAB ID | M | | 9.2.23 | | — | — |
| >>>E-RAB Level | M | | 9.2.9 | Includes | — | — |
| QoS Parameters | | | | necessary | | |
| | | | | QoS pa- | | |
| | | | | rameters | | |
| >>>DL Forwarding | O | | 9.2.5 | | — | — |
| >>>UL GTP | M | | GTP | SGW | — | — |
| Tunnel Endpoint | | | Tunnel | endpoint of | | |
| | | | Endpoint | the S1 | | |
| | | | 9.2.1 | transport | | |
| | | | | bearer. For | | |
| | | | | delivery of | | |
| | | | | UL PDUs. | | |
| >RRC Context | M | | OCTET | Includes the | — | — |
| | | | STRING | RRC | | |
| | | | | Handover | | |
| | | | | Preparation | | |
| | | | | Information | | |
| | | | | message as | | |
| | | | | defined in | | |
| | | | | subclause | | |
| | | | | 10.2.2 of TS | | |
| | | | | 36.331 [9] | | |
| >Handover Re- | O | | 9.2.3 | | — | — |
| striction List | | | | | | |
| >Location | O | | 9.2.21 | Includes the | — | — |
| Reporting In- | | | | necessary pa- | | |
| formation | | | | rameters for | | |
| | | | | location | | |
| | | | | reporting | | |
| >Management | O | | 9.2.59 | | YES | ignore |
| Based MDT | | | | | | |
| Allowed | | | | | | |
| >ManagementBase | O | | MDT | | YES | ignore |
| dMDT PLMN List | | | PLMN | | | |
| | | | List | | | |
| | | | 9.2.64 | | | |
| UE History In- | M | | 9.2.38 | Same | YES | ignore |
| formation | | | | definition as | | |
| | | | | in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility In- | O | | BIT | Information | YES | ignore |
| formation | | | STRING | related to the | | |
| | | | (SIZE | handover; the | | |
| | | | (32)) | source eNB | | |
| | | | | provides it in | | |
| | | | | order to | | |
| | | | | enable later | | |
| | | | | analysis of | | |
| | | | | the | | |
| | | | | conditions | | |
| | | | | that led to a | | |
| | | | | wrong HO. | | |
| Source Radio | O | | | Information | — | ignore |
| Resource | | | | related to the | | |
| Management in- | | | | current | | |
| formation | | | | source eNB | | |
| | | | | RRM in case | | |
| | | | | of small cell | | |
| | | | | existing | | |

Referring to Table 1, the handover request message includes the “E-RABs To Be Setup List” field for the small cell, and the “E-RABs To Be Setup List” field for the macro eNB. Further, the handover request message includes the “Source Radio Resource Management information” field which indicates information related to the current source eNB RRM in case of small cell existing.

In the description above, as an exemplary, the handover request message is used for differentiation of the E-RABs for the small cell and the E-RABs for the macro eNB. However, the present invention is not limited thereto, and other message which is a newly defined message or the existing message may used for differentiation of the E-RABs for the small cell and the E-RABs for the macro eNB. Also, the information on current radio resource management of the source macro eNB 1 may be transmitted by using other message which is a newly defined message or the existing message.

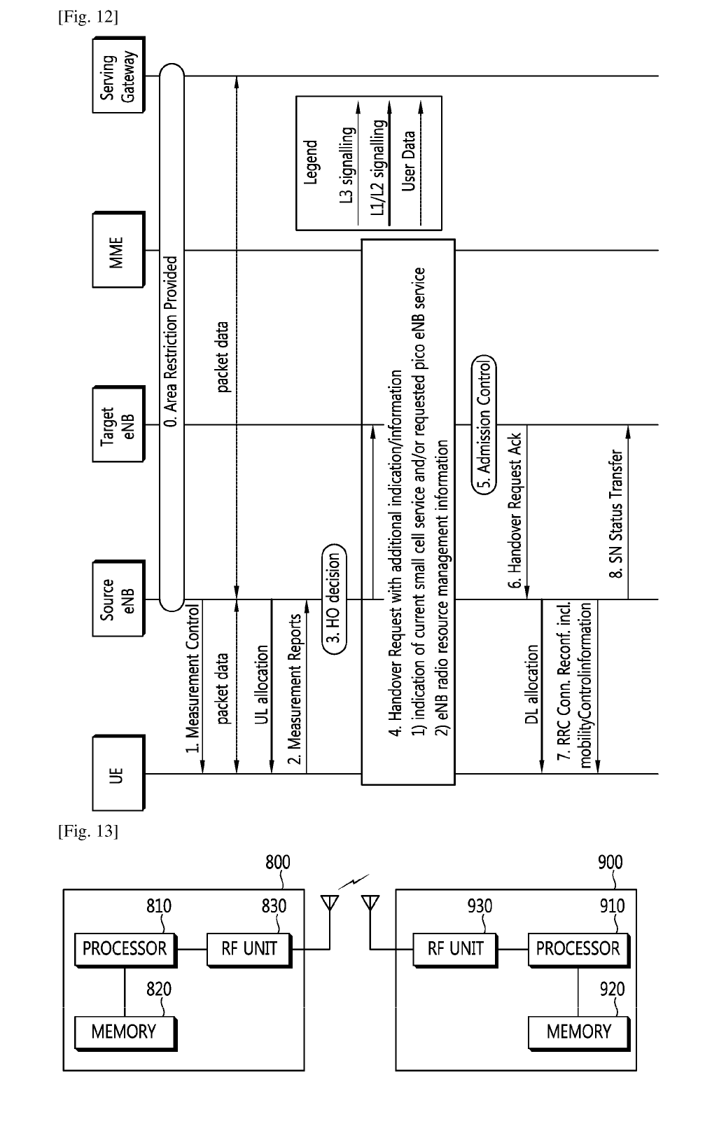

FIG. 12 shows an example of a method for transmitting a handover request message according to another embodiment of the present invention. FIG. 12 shows an embodiment in which all services of the UE is handed over from a source macro eNB 1 to a pico eNB which controls a small cell currently. That is, the embodiment described in FIG. 12 corresponds to the embodiment described in FIG. 10.

0. The UE context within the source macro eNB 1 contains information regarding roaming restrictions which were provided either at connection establishment or at the last TA update.

1. The source macro eNB 1 configures the UE measurement procedures according to the area restriction information. Measurements provided by the source macro eNB 1 may assist the function controlling the UE's connection mobility.

2. The UE transmits the measurement report to the source macro eNB 1, which makes a decision for handover all services of the UE to the small cell, which currently provides a part of services for the UE.

3. The source macro eNB 1 makes decision based on measurement reports and RRM information to hand off the UE.

4. The source macro eNB 1 transmits the handover request message to the target macro eNB2.
The handover request message may include an indication indicating that the “E-RABs To Be Setup List” field in the handover request message is for the small cell or the pico eNB. The E-RABs for the small cell correspond to the service which is served currently by the small cell. The E-RABs for the pico eNB correspond to the service which is to be newly set up in the small cell, i.e., service which is to be served by the small cell after the X2 handover procedure is completed. Thus, by the indication, the pico eNB can differentiate the E-RABs for the small cell and the E-RABs for the pico eNB.
The handover request message may include the “E-RABs To Be Setup List” field for the small cell and the “E-RABs To Be Setup List” field for the pico separately with note. The E-RABs for the small cell correspond to the service which is served currently by the small cell. The E-RABs for the pico eNB correspond to the service which is to be newly set up in the small cell, i.e., service which is to be served by the small cell after the X2 handover procedure is completed. Thus the pico eNB can differentiate the E-RABs for the small cell or E-RABs for the pico eNB.
The handover request message may also include information on current radio resource management of the source macro eNB 1, by which the pico eNB can use similar RRM so that the small cell's service can be guaranteed smoothly even after the handover procedure is completed.

5. The pico eNB adopts different actions for the E-RABs for the small cells and the

E-RABs for the pico eNB. For example, deciding which E-RABs should be newly setup, QoS guarantee, deciding whether to transmit a handover request ACK message, deciding of path switch, deciding of data forwarding, etc., may be performed differently according to the E-RABs for the small cells and the E-RABs for the pico eNB.

Subsequent procedures may be the same as the conventional X2 handover procedure, which is described in FIGS. 5 and 6 (from step 6 to 18).

Table 2 shows another example of the handover request message according to the embodiment of the present invention.

TABLE 2

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.13 | | YES | reject |
| Old eNB UE X2AP | M | | eNB UE | Allocated at | YES | reject |
| ID | | | X2AP ID | the source | | |
| | | | 9.2.24 | eNB | | |
| Cause | M | | 9.2.6 | | YES | ignore |
| Target Cell ID | M | | ECGI | | YES | reject |
| | | | 9.2.14 | | | |
| GUMMEI | M | | 9.2.16 | | YES | reject |
| UE Context In- | | 1 | | | YES | reject |
| formation | | | | | | |
| >MME UE S1AP | M | | INTEGER | MME UE | — | — |
| ID | | | (0 . . . 2³²- | S1AP ID | | |
| | | | 1) | allocated at | | |
| | | | | the MME | | |
| >UE Security Capa- | M | | 9.2.29 | | — | — |
| bilities | | | | | | |
| >AS Security In- | M | | 9.2.30 | | — | — |
| formation | | | | | | |
| >UE Aggregate | M | | 9.2.12 | | — | — |
| Maximum Bit Rate | | | | | | |
| >Subscriber Profile | O | | 9.2.25 | | — | — |
| ID for RAT/ | | | | | | |
| Frequency priority | | | | | | |
| >E-RABs To Be | O | 1 | | | — | — |
| Setup List (Small | | | | | | |
| cell) | | | | | | |
| >>E-RABs To Be | | 1 . . . | | | EACH | ignore |
| Setup Item | | <maxnoof | | | | |
| | | Bearers> | | | | |
| >>>E-RAB ID | M | | 9.2.23 | | — | — |
| >>>E-RAB Level | M | | 9.2.9 | Includes | — | — |
| QoS Parameters | | | | necessary | | |
| | | | | QoS pa- | | |
| | | | | rameters | | |
| >>>DL Forwarding | O | | 9.2.5 | | — | — |
| >>>UL GTP | M | | GTP | SGW | — | — |
| Tunnel Endpoint | | | Tunnel | endpoint of | | |
| | | | Endpoint | the S1 | | |
| | | | 9.2.1 | transport | | |
| | | | | bearer. For | | |
| | | | | delivery of | | |
| | | | | UL PDUs. | | |
| >E-RABs To Be | | 1 | | | — | — |
| Setup List (Pico | | | | | | |
| eNB) | | | | | | |
| >>E-RABs To Be | | 1 . . . | | | EACH | ignore |
| Setup Item | | <maxnoof | | | | |
| | | Bearers> | | | | |
| >>>E-RAB ID | M | | 9.2.23 | | — | — |
| >>>E-RAB Level | M | | 9.2.9 | Includes | — | — |
| QoS Parameters | | | | necessary | | |
| | | | | QoS pa- | | |
| | | | | rameters | | |
| >>>DL Forwarding | O | | 9.2.5 | | — | — |
| >>>UL GTP | M | | GTP | SGW | — | — |
| Tunnel Endpoint | | | Tunnel | endpoint of | | |
| | | | Endpoint | the S1 | | |
| | | | 9.2.1 | transport | | |
| | | | | bearer. For | | |
| | | | | delivery of | | |
| | | | | UL PDUs. | | |
| >RRC Context | M | | OCTET | Includes the | — | — |
| | | | STRING | RRC | | |
| | | | | Handover | | |
| | | | | Preparation | | |
| | | | | Information | | |
| | | | | message as | | |
| | | | | defined in | | |
| | | | | subclause | | |
| | | | | 10.2.2 of TS | | |
| | | | | 36.331 [9] | | |
| >Handover Re- | O | | 9.2.3 | | — | — |
| striction List | | | | | | |
| >Location | O | | 9.2.21 | Includes the | — | — |
| Reporting In- | | | | necessary pa- | | |
| formation | | | | rameters for | | |
| | | | | location | | |
| | | | | reporting | | |
| >Management | O | | 9.2.59 | | YES | ignore |
| Based MDT | | | | | | |
| Allowed | | | | | | |
| >ManagementBase | O | | MDT | | YES | ignore |
| dMDT PLMN List | | | PLMN | | | |
| | | | List | | | |
| | | | 9.2.64 | | | |
| UE History In- | M | | 9.2.38 | Same | YES | ignore |
| formation | | | | definition as | | |
| | | | | in TS 36.413 | | |
| | | | | [4] | | |
| Trace Activation | O | | 9.2.2 | | YES | ignore |
| SRVCC Operation | O | | 9.2.33 | | YES | ignore |
| Possible | | | | | | |
| CSG Membership | O | | 9.2.52 | | YES | reject |
| Status | | | | | | |
| Mobility In- | O | | BIT | Information | YES | ignore |
| formation | | | STRING | related to the | | |
| | | | (SIZE | handover; the | | |
| | | | (32)) | source eNB | | |
| | | | | provides it in | | |
| | | | | order to | | |
| | | | | enable later | | |
| | | | | analysis of | | |
| | | | | the | | |
| | | | | conditions | | |
| | | | | that led to a | | |
| | | | | wrong HO. | | |
| Source Radio | O | | | Information | — | ignore |
| Resource | | | | related to the | | |
| Management in- | | | | current | | |
| formation | | | | source eNB | | |
| | | | | RRM in case | | |
| | | | | of small cell | | |
| | | | | existing | | |

Referring to Table 2, the handover request message includes the “E-RABs To Be Setup List” field for the small cell, and the “E-RABs To Be Setup List” field for the pico eNB. Further, the handover request message includes the “Source Radio Resource Management information” field which indicates information related to the current source eNB RRM in case of small cell existing.

In the description above, as an exemplary, the handover request message is used for differentiation of the E-RABs for the small cell and the E-RABs for the pico eNB. However, the present invention is not limited thereto, and other message which is a newly defined message or the existing message may used for differentiation of the E-RABs for the small cell and the E-RABs for the pico eNB. Also, the information on current radio resource management of the source macro eNB 1 may be transmitted by using other message which is a newly defined message or the existing message.

FIG. 13 shows a wireless communication system to implement an embodiment of the present invention.

A first eNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A second eNB 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for transmitting, by a first macro eNodeB (eNB), a handover request message in a wireless communication system, the method comprising:
transmitting a handover request message including a list of first services for a user equipment (UE), which are provided by the first macro eNB, and a list of second services for the UE, which are provided by a small cell eNB which has dual connectivity with the first macro eNB.

2. The method of claim 1, further comprising:
handing over the UE to a second macro eNB which supports dual connectivity potentially with the small cell eNB.

3. The method of claim 2, wherein the handover request message is transmitted to the second macro eNB.

4. The method of claim 2, wherein the first services are handed over to the second macro eNB.

5. The method of claim 2, wherein the second services are totally kept in the small cell eNB; or
wherein the second services are not kept in the small cell eNB but indirectly handed over from the small cell eNB to the second macro eNB going through the first macro eNB.

6. The method of claim 1, further comprising:
handing over the UE to a pico eNB which is the small cell eNB.

7. The method of claim 6, wherein the handover request message is transmitted to the pico eNB.

8. The method of claim 6, wherein the first services are handed over to the pico eNB.

9. The method of claim 6, wherein the second services are kept in the small cell eNB.

10. The method of claim 1, wherein the list of first services corresponds to a list of first E-UTRAN radio access bearers (E-RABs).

11. The method of claim 1, wherein the list of second services corresponds to a list of second E-UTRAN radio access bearers (E-RABs).

12. The method of claim 1, wherein the handover request message includes information on current radio resource management of the first macro eNB.

13. The method of claim 1, further comprising:
receiving a measurement report from the UE.

14. A method for receiving, by a second macro eNodeB (eNB), a handover request message in a wireless communication system, the method comprising:
receiving a handover request message including a list of first services for a user equipment (UE), which are provided by a first macro eNB, and a list of second services for the UE, which are provided by a small cell eNB which has dual connectivity with the first macro eNB, from the first macro eNB; and
providing the first services to the UE.

15. A method for receiving, by a pico eNodeB (eNB), a handover request message in a wireless communication system, the method comprising:
receiving a handover request message including a list of first services for a user equipment (UE), which are provided by a first macro eNB, and a list of second services for the UE, which are provided by a small cell eNB which has dual connectivity with the first macro eNB, from the first macro eNB; and
providing both the first services and the second services to the UE, wherein the pico eNB is the small cell eNB.
